(19) United States
(12) Patent Application Publication
(10) Pub. No.: US 2002/0159835 A1
(43) Pub. Date: Oct. 31, 2002

(54) Reflective pavement marker and method of making

(76) Inventor: Adil Attar, Claremont, CA (US)

Correspondence Address: ADIL ATTAR, P.O. Box 3883, Ontario, CA, 91761, US

(21) Appl. No.: 09/800,443

(22) Filed: Mar. 5, 2001

Related U.S. Application Data
(63) Continuation-in-part of application No. 09/419,741, filed on Oct. 16, 1999, now Pat. No. 6,267,530.

(51) Int. Cl. G08B 1/00

(52) U.S. Cl. 404/16

(57) ABSTRACT

A reflective pavement marker having monolithically molded one-piece structural body having multiple of hollow cavities which are defined by the partition and load carrying walls with wedge shaped top surfaces, said hollow cavities open within a recessed portion of reflective faces of said marker body, two arcuate sides and integrally sealed planar base surface with textures and discontinuous grooves.

The reflective plates are welded on said wedge shaped top surfaces of the hollow cavity walls. This marker provide a mean to enhance the reflective cell sizes, improved impact resistance and improve resistance to flexural stresses due to automobiles impact forces; this is accomplished by maximizing the base surface area for adhesive wetting parameter. The body can be made of various recycled or virgin structural plastics with high impact resistance and UV stability.

### BACKGROUND OF THE INVENTION

1. Field of the Invention

This invention relates to reflective roadway markers that are used for traffic lane delineation, in particular, to markers with enhanced reflectivity, impact resistant, sealed base surface and low cost.

2. Related Art

Roadway markers are adhered to pavements along centerlines, edge lines, lane dividers or guardrail delineators. Other roadway markers are used as temporary lane dividers in temporary constructions, detours or prior to permanent marking of newly paved roadways. Since 1965, the most commonly used reflective roadway markers are based on Heenan U.S. Pat. No. 3,332,327 or Balint U.S. Pat. No. 3,409,344. Typically, this type of markers is produced in a process consisting of four to five steps: First, injection molding of a thermoplastic shell, either integrally molded with the reflective face, or the reflective faces welded on a corresponding open recesses within the shell. The reflective face, having 350 or more cube corner reflective elements on each reflective face of the shell. Secondly, either the cube corner reflective elements within a shell or the entire inside surface of the shell coated with a reflective sealer by a process known as vacuum metalizing. This metallic sealer needed to seal the cube corner reflective elements so they retain part of their reflectivity prior to the next step, of filling the shell with a thermosetting resinous material, such as epoxy or polyurethane.

This resinous filler material encapsulate the metalized cube corner reflective elements and give the marker the structural body. Finally, a layer of relatively course sand or glass beads dispersed over the top surface of the filler material prior to solidification of the filler material.

Part of the sand particles will remain partially protruding above this planar surface of the marker base, thereby increase the adhesive wetting parameter of the base surface. This will improve adhesion to substrate, regardless of the type of adhesive used. This type of markers worked well for six or seven months, however, due to poor abrasion and impact resistant of the thermoplastic shell, nearly 60% of the reflectivity is lost thereafter. Also, since the coefficient of thermal expansion of the shell material and the resinous filler material vary, this causes pealing of the reflective face or the shell from the resinous body, thereby losing reflectivity. Several attempt were made to improve abrasion resistant of the reflective face. One was the use of thin layer of glass, in U.S. Pat. No. 4,340,319, Another attempt was the use of polymeric coating of the reflective face, as disclosed in U.S. Pat. No. 4,753,548 to Forrer. These abrasion resistant coating proving to be expensive and tend to reduce reflectivity. Other major development in the pavement marker art has been made in the attempt to eliminate the use of the metalized sealer for the cube corner reflective elements. This has been achieved by dividing the inside surface of the reflective face into reflective cells, each cell will have several cube cor mer reflective elements, the cells isolated from each other by partition and load carrying walls. The entire reflective face welded to corresponding recesses within a hollowed or solid body. This method is disclosed in U.S. Pat. No. 4,227,772 (Heenan); U.S. Pat. Nos. 4,232,979; and 4,340,319 (Johnson et al); U.S. Pat. No. 4,498,733 to (Flanagan). These markers proved to be superior in reflectivity, however, lack of enough adhesive wetting parameter lead to poor adhesion to roadways, hence caused short life cycle for this type of markers. This applicant successfully developed two markers with non-metalized multi-cell reflective roadway. One roadway marker utilizes raised rhombic shaped abrasion reducing and load transferring raised ridges, which act to intercede abrasion elements and impact load, the shell filled with impact resistant epoxy.

The marker body is having a base with large wetting parameter for shear and flexural strength, as disclosed in U.S. Pat. No. 4,726,706 to Attar.

The second roadway marker of this applicant, U.S. Pat. No. 5,927,897 developed a mean to increase the abrasion resistant of the reflective face by coating the reflective face with diamond-like film and by having holding pins extended beyond the partition walls into the body, the holding pins sealed by the filler material; this works very effectively, providing structural strength and maximum adhesive wetting parameter. The entire above reflective pavement markers are incorporated herein by reference in their entireties. Applicant present goal to have a roadway marker having: high reflectivity, enhance structural body, abrasion resistant, low cost, marker base area with maximum wetting parameter and very simple yet consistent process to manufacture.

### SUMMARY OF THE INVENTION

This invention provide a novel raised pavement marker that comprises means to formed the body with hollow cavities, said hollow cavities having wedge shaped top surfaces at the open ends within a recessed portion of the reflective faces. At least one reflective face having multiple of cube corner reflective elements sonically welded on said wedge shaped top surfaces, thereby forming air gaps beneath the reflective elements, said body is formed with sealed base and large adhesive wetting parameter for better adhesion to the pavement and higher resistance to flexural stresses.

The primary object of this invention is to eliminate the multi steps process in prior arts for making reflective and non-reflective pavement markers while retaining maximum base surface area, maximum reflective faces and minimum partition and load carrying spacing.

Another objective of this invention is to provide a raised roadway marker made of high impact, abrasion resistant material, and low cost. The present invention further provides a method of making one piece body for raised roadway markers of any desirable shape and configuration. In accordance with still further aspect of this invention, the marker can be made with one or two reflective faces, this will cost considerably less to install to the roadway, or two multi colored parts can be welded together, each with one reflective face opposite the other.

### BRIEF DESCRIPTION OF THE DRAWINGS

These drawings are schematics, no scale used. In the drawings:

FIG. 1 is an isometric view of a preferred one-piece marker body and a reflective plate;

FIG. 2 is a plan view of the pavement marker illustrated in FIG. 1;

FIG. 3 is an elevation view of the pavement marker body, as in FIG. 1;

FIG. 4 is a cross section view taken along the line 4-4 of marker body, as in FIG. 2;

FIG. 4b is a sectional view taken along line 4b-4b of FIG. 2;

FIG. 5 is isometric view of marker in FIG. 1 showing planar base surface with discontinuous grooves;

FIG. 6 is a view of a reflective plate for attachment in the one-piece body of marker in FIG. 1;

FIG. 7 is isometric view of another embodiment of marker with one-piece body of the invention;

FIG. 8 is isometric view of marker body as in FIG. 7 showing a sea ted and grooved planar base surface;

FIG. 9 is a plan view of the marker body in FIG. 7 showing the curved sides and reflective face;

FIG. 10 is a cross section view taken along the line 10-10 in FIG. 9;

FIG. 11 is an elevation view of the marker body as in FIG. 7;

FIG. 12 is an isometric view of a spherical embodiment of marker with hollow body of the invention;

FIG. 12a is a spherical cap with built in reflective cells for the marker body as in FIG. 12;

FIG. 13 is a plan view of the cap portion and the marker body, as in FIG. 12;

FIG. 14 is an elevation view of the cap portion and the marker body in FIG. 12;

FIG. 15 is a plan view of a non-reflective marker with spherical body and raised ridges;

FIG. 16 is a section view along line 16-16 of marker body, as in FIG. 15;

FIG. 17 is an isometric view showing part of another preferred embodiment of the invention;

FIG. 18 is a plan view of the reflective marker part in FIG. 17 with attached reflective plate;

FIG. 19 is a plan view of welded two parts forming two ways marker based on FIG. 17 part;

FIG. 20 is a cross sectional view taking along line 20-20 in FIG. 19;

FIG. 21 is an isometric view of another preferred reflective marker embodiment of the invention;

FIG. 22 is a plan view of reflective of the one-piece marker body, as in FIG. 21;

FIG. 23 is a cross sectional view taking along line 23-23 of marker body, as in FIG. 21;

FIG. 24 is an elevation view of the one-piece reflective marker body, as in FIG. 21.

### DETAIL DESCRIPTION OF PREFERRED EMBODIMENTS

Durable, cost effective and simplified production method of reflective and non-reflective pavement markers with maximum resistant to flexural stresses is being presented in this invention, said marker having a monolithically formed one piece structural body that includes textured and sealed base surface area, thereby producing a lightweight marker body integrally in one step from one of various available structural polymers, said marker body can be integrally formed in such a way reducing excessive material while retaining structural strength and optimum adhesive wetting area for the base surface. This invention satisfies the above conditions.

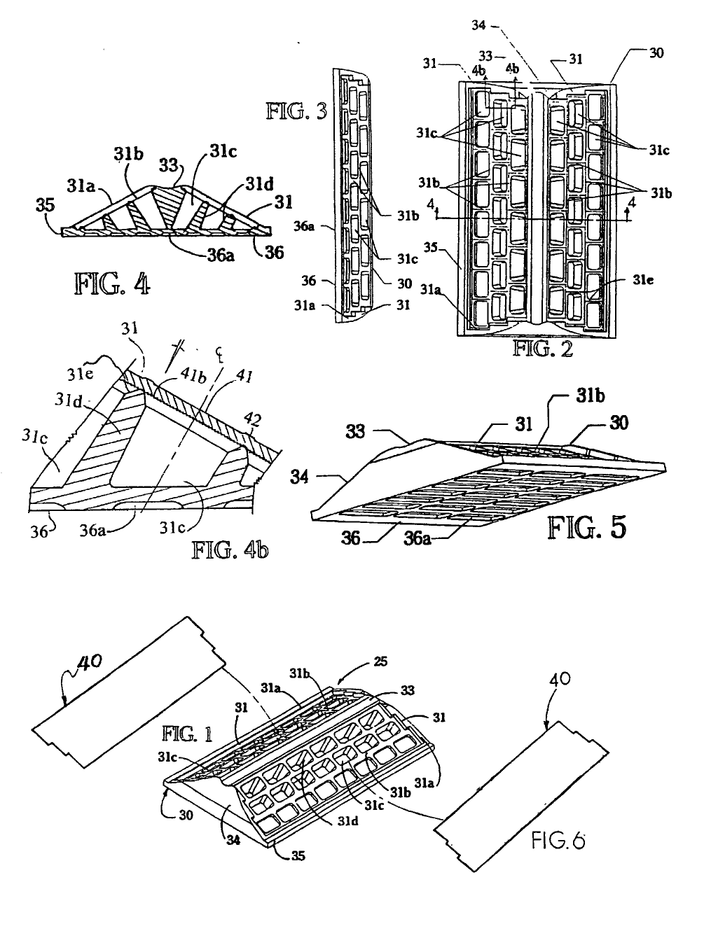

Referring to FIG. 1 to 6 represent one of the preferred embodiments of the marker designated by the number 25 which comprises as one piece structural body 30 integrally includes multiple of hollow cavities 31c and at least one reflective plate 40 attachment. Structural body 30 integrally having two inclined planar faces 3 for reflective plate 40 attachment, two arcuate sides 34, a top portion 33 and sealed planar base surface 36 that includes multiple of textured arcuate grooves 36a. The inclined faces 31, each having a planar surface 31a and a recessed portion 31b where a reflective plate 40 can be welded or agglutinated. Recessed portion 31b is where the wedged shaped top surfaces 31e of walls 31d defining hollow cavities 31c are located. Hollow cavities 31c, each having centerline near perpendicular to the inclined planar faces 31. FIG. 4b shows a section view of a hollow cavity 31c showing the cavity walls 31d having wedged shaped top portion 31e. Each of wedged shaped top surfaces 31e can have slightly round top surface. Each wall 31d forming an angle, preferably about 2 to 5 degrees with respect to the center line of said hollow cavities. Hollow cavities 31c having a depth that can be terminated about 0.05 to 0.15 inch above the sealed outside planar base surface 36 with an extended lips 35.

This depth for hollow cavities 31c allows body 30 to retain a solidly sealed base surface. The thickness of hollow cavity walls 31d at the lower end of wedge shaped top surface 31e is about 0.07 to 0.20 inch at the planar recess portion 31b of the inclined planar face 31.

The inclined planar faces 31 form an acute angle with respect to the planar base surface 36, said acute angle, preferably having a value of about 10 to 30 degrees. The reflective plate 40 is welded to the wedged shaped top surfaces 31e of the hollow cavity walls 31d and to the periphery of the recessed portion 31b, fusing thin portion of the inside of reflective plate 40 to said surfaces, thereby forming a cell like reflective segments within the inside surface of plate 40. Each of said cells having multiple cube-corner reflective elements 41b freely open within each corresponding hollow cavity 31c. The relatively thick walls 31d, integrally with wedge shaped top surface 31e will significantly improve the impact resistance of body 30 as well as maximizing the cells inside surface areas after welding the reflective plate 40 to body 30.

The air gap formed beneath the cube comer reflective elements within each hollow cavity 31c, allows maximum reflectivity without the need for metalizing the reflective elements. The outside surface of the reflective plate 40 will have corresponding cell like planar reflective areas 41, nearly having similar shapes as the open ends of cavities 31c bellow them. Preferably, the outside cell like planar areas 41 will be recessed about 0.001 to 0.010 inch bellow the planar surface of the reflective plate 40, defining ridge like walls 42. Several shapes or sizes of hollow cavity 31c can be selected for marker body 30, hence forming a corresponding cell like planar reflective areas 41 for the reflective plate 40.

The following U.S. Patents provides suitable reflective plate or cube comer reflective element design, U.S. Pat. No. 3,712,706 to Stamm, U.S. Pat. No. 4,208,090 to Heenan, U.S. Pat. No. 4,232,979 to Johnson, U.S. Pat. No. 4,498,733 to Flanagan and U.S. Pat. No. 4,726,706 to Attar, all of which are incorporated herein as reference in their entireties. Reflective plate 40 can be coated for abrasion resistance with diamond-like carbon film or silicon dioxide, or even higher oxygen percentage, using plasma enhanced chemical vapor deposition techniques. One of the preferred method is using radio frequency plasma decomposition from an alkane, such as n-butane, propane, or other gases with a pair of spaced pure carbon electrodes. Pavement marker body can have any commonly used size or shape. Preferably, the base area 36 will have about 4.0 to 5.0 inches in width, and the depth to be about 2.0 to 4.0 inches and the marker height can be about 0.50 to 0.70 inch. Several recycled or virgin polymeric materials are available. Such polymers must be compatible to the reflective plate 40 material and suitable for the production of marker body 30. Typically, the polymer material used to make the reflective plates 40 is transparent acrylic or polycarbonate thermoplastic.

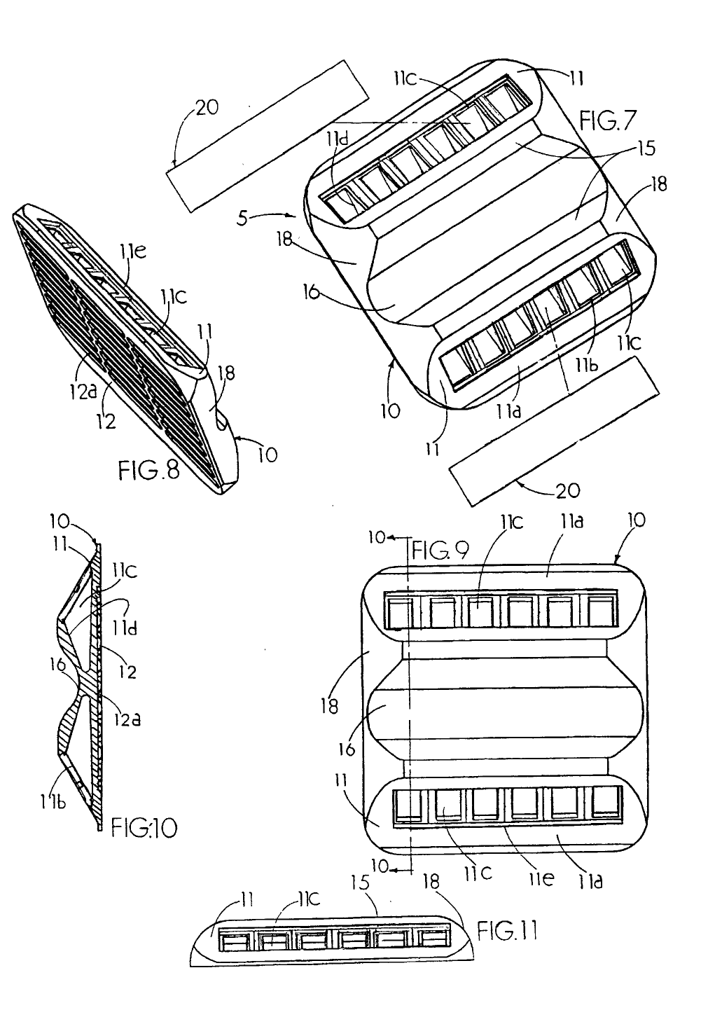

Referring to FIG. 7 through 11, there is shown an alternative embodiment of a roadway marker 5 having a body 10 integrally formed from any desired structural polymer, said marker body 10 having two hump portions 15, each integrally having concave curve shaped reflective face 11 which includes a planar recessed portion 11a, said recessed portion having open ends of hollow cavities 11c and the wedged shaped top surfaces 11b of load carrying walls 11d defining said hollow cavities. The two hump portions 15 are integrally connected by a scalloped recess portion 16. The marker body also having two arcuate sides 18 and sealed planar base surface 12 with textured and grooved surface 12a. Hollow cavities 11c, each having a wedge shaped top surface 11b recessed bellow the curved surface 11a and inwardly tapered partition walls 11d.

The centerline of each hollow cavity 11c is parallel to the planar base surface 12. Reflective plate 20 having multiple of cube corner reflective elements on the inside surface, and planar outside surface. Plate 20 can be welded or agglutinated to the wedged shaped top surfaces 11b within the recessed area 11a, thereby having the remaining cube corner reflective elements sealed freely within air gap areas inside of each corresponding hollow cavities 11c.

Reflective plate 20 can be coated with abrasion resistant diamond-like carbon film, or silicon dioxide film, to enhance durability and scratch resistant.

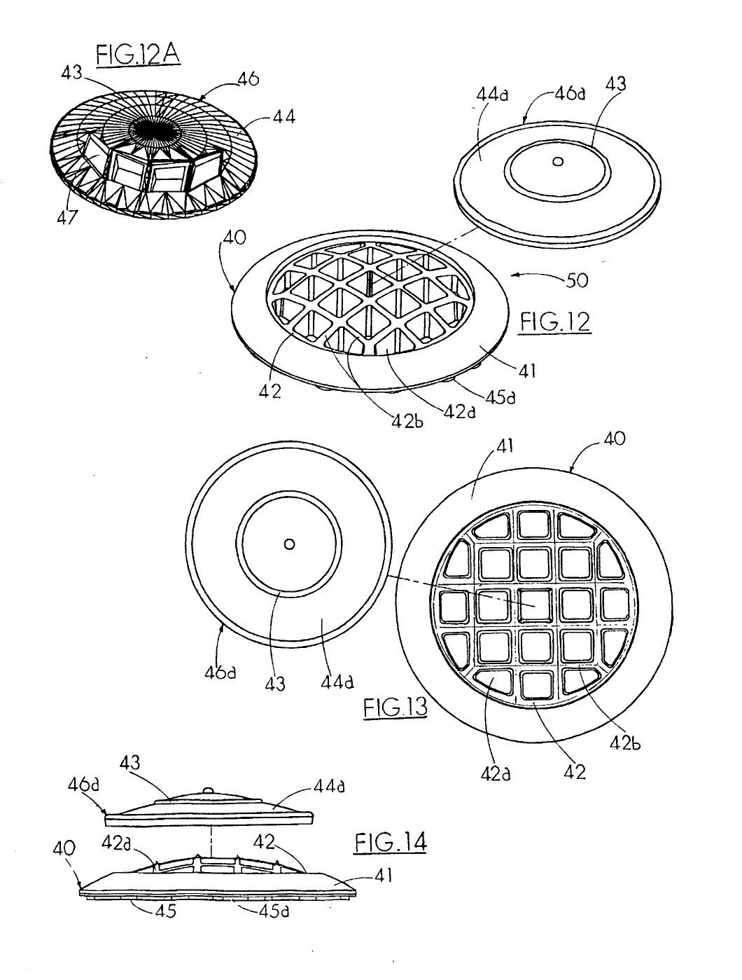

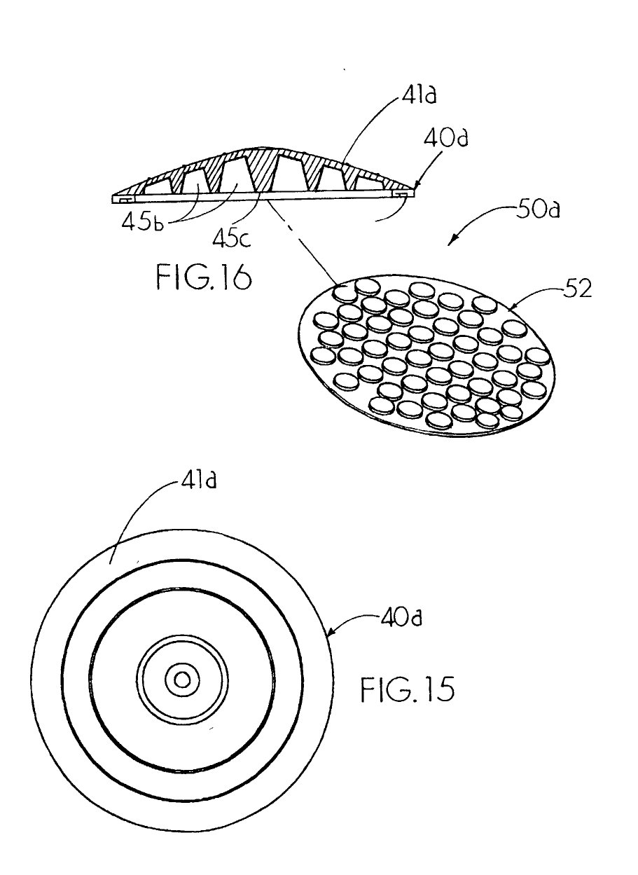

FIGS. 12 through 16 illustrate yet another embodiment of reflective or non-reflective roadway markers, in accordance to the present invention. Marker 50 has an integrally made body 40 having a rounded spherical shaped top surface 41 with a slightly recessed center portion 42, said center portion 42 divided into multiple hollow cavities 42a by partition and load carrying walls 42b. Walls 42b are tapered inward, forming 3 to 5 degrees angle with respect to the centerline of each hollow cavity 42a. Hollow cavities 42a terminate about 0.10 inch above the sealed outside planar base surface 45 with raised pens 45a, said raised pens 45a protrude less than 0.06 inch beyond the sealed planar base surface 45. When cap portion 46a is attached to body 40, a non-reflective marker 50 is formed. Cap portion 46a has thickness and contour correspond to the recessed center portion 42 of body 40. Cap portion 46a having an outside surface with raised ridges 43. FIG. 12A shows cap portion 46. Cap portion 46 having outside spherical surface 44 integrally built with raised ridges 43 and multiple of reflective cells 47, each cell with planar outside surface and multiple of cube corner reflective elements on the inside of said reflective cells 47. The inside surface of cap portion 46 can be integrally textured with either small spherical shaped surface, wedged ridges, cube corner shaped surface or any combination of such texturing surface for added brightness and welding parameter. When cap portion 46 to be used, the entire shapes and sizes of hollow cavities 42a have to be formed to correspond to reflective cells 47.

Reflective cells 47 having the outside planar surface integrally positioned about 28 to 30 degrees with respect to the planar base surface 45. Each reflective cell also forms an angle with respect to adjacent cell, said angle to have a value of not more than 30 degrees. Each cell 47 welded directly on the vertex of wedge shaped top surfaces of hollow cavity walls 42b, thereby forming air gap directly beneath the cube corner reflective elements within each cell.

Cap portion 46 can be made of impact resistant and transparent polymeric material. Such polymeric materials are available either as a recycled or virgin. When color reflectors are desired, a transparent pigment will be added to the polymer.

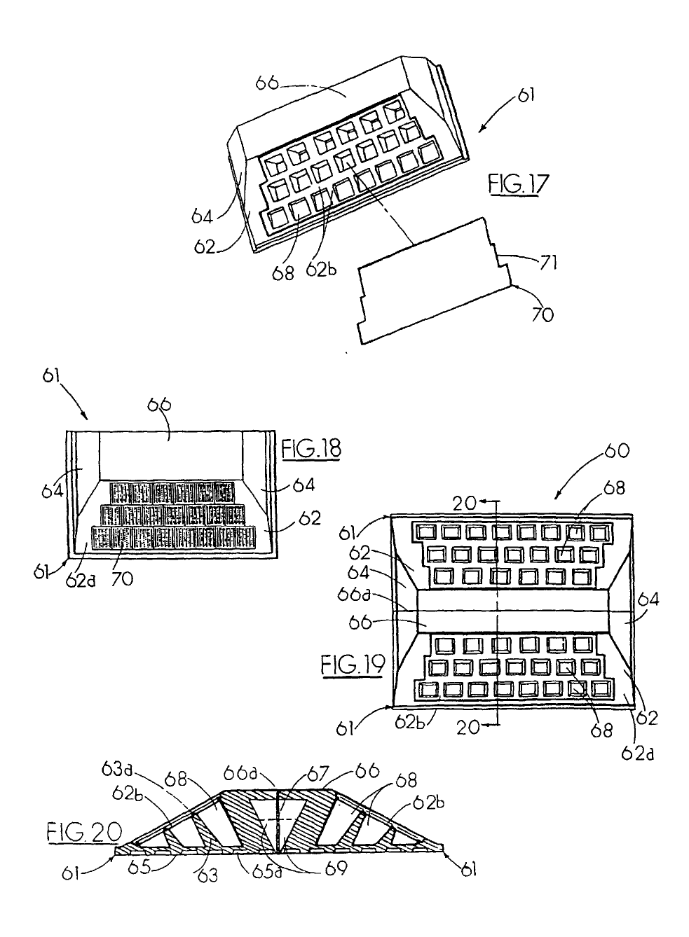

Marker 50a is another preferred embodiment of a non-reflective marker based on the present invention. Marker 50a can be made from recycled or virgin plastics such as ABS, Polypropylene, engineered plastic or any suitable high strength polymer. Engineered plastic is commonly refers to thermosetting or thermoplastic polymers with various proportions of fiber reinforcement and/or inert materials added. Several compositions of this type of polymers are available and readily marketed, either as a recycled or virgin polymer. Marker 50a having one-piece body 40a with sealed spherical top surface 41a, said body 40a including multiple hollow cavities 45b, each with an open end at a recessed part 45c of planar base surface 45a. Each hollow cavity 45b ends approximately 0.10-inch bellow the outside spherical surface 41a. A planar cap portion 52 can be welded to the recessed part 45c of the planar base surface 45a where the open ends of hollow cavities 45b are located. These types of reflective or non-reflective markers can effectively be used to replace the highly brittle ceramic markers, because it can retain surface brightness due to having minimum contact to tire surfaces, maximum base adhesive wetting parameter and lower production cost and shorter production cycle due to the multiple hollow cavities within the marker's body. Markers 50 and 50b can be coated with abrasion resistant vapor deposited diamond like film or silicon dioxide film for added surface enhancement and durability. Another preferred embodiment is roadway marker 60, as illustrated in FIG. 11 through 22. Marker 60 ideally suited for use as a multi colored or one color marker with two reflective sides. Marker 60 can be formed having two parts 61 connected with a tear able thin wedge 66a. The two parts welded or agglutinated at the backside 67.

Each part 61 integrally comprises a planar top surface 66, a sealed planar base surface 65 with textured grooves 65a, two multi angled sides 64, an inclined planar face 62 and backside 67 vertical with respect to planar base surface 65, said backside including hollow cavities 69. The inclined planar face 62 includes a planar surface 62a and recessed portion 62b. Recessed portion 62b having the open ends of hollow cavities 68 and the wedge shaped top surfaces 63a of hollow cavity walls 63 that separate said hollow cavities from each other. The planar face 62 preferably inclined about 28 to 30 degrees with respect to the sealed planar base surface 65. A reflective plate 70 which has a corresponding size and shape of the recessed portion 62b is either welded or agglutinated to the wedge shaped top surface 63a, thereby retaining cell like inside areas of the reflective plate with cube comer reflective elements tightly within an air gap inside each corresponding hollow cavity 68. Hollow cavities 68 integrally formed having a centerline near perpendicular to planar face 62 and a depth that terminate about 0.05 to 0.10 inch above the planar base surface 65.

Hollow cavity walls 63 form an inward angle of about 2 to 5 degrees with respect to each centerline of the corresponding hollow cavity.

Another forms of hollow cavities 69 open within the backside 67, said cavities 69 can be of any eject able shape. Cavities 69 are used to minimize the extra wasted polymeric material used to make part 61 without hampering the structural integrity of said part 61. Part 61 can be made of various recycled or virgin polymeric materials comparable to material of reflective plate 70 with the desired color added. Reflective plate 70 can have either planar outside surface or slightly recessed cell like planar surfaces corresponding to the shapes of the opening of the hollow cavities 68. The inside surface of reflective plate 70 is formed with multiple cube-comer reflective elements. The inside of reflective plate 70 is sonically welded to the wedge shaped top surface 63a of hollow cavity walls 63. Hence cell-like areas formed on said inside surface of reflective plate 70, each cell can retain multiple of the cube-comer reflective elements within a corresponding hollow cavity 68.

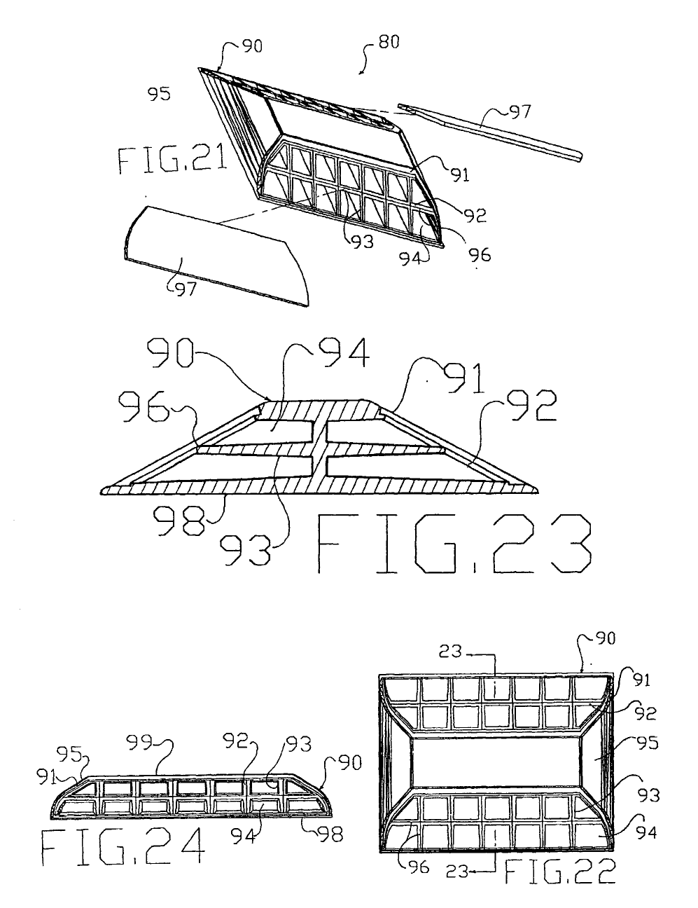

FIG. 21 through FIG. 24 illustrate yet another preferred embodiment of the present invention. Marker 80 which comprises of a monolithically formed one piece hollowed structural body 90 and two reflective plates 97 for attachment, said body 90 comprises of two reflective faces 91, two arcuate sides 95, textured and sealed base surface 98 with discontinuous grooves and planar top surface 99, said inclined reflective faces 91 each having a recessed planar portion 92 where the reflective plates 97 are welded, said recessed portions 92, each includes wedged shaped top surfaces 96 of the load carrying partition walls 93, each partition wall 93 having surfaces that are inwardly inclined at an angle of about 2 to 5 degrees with respect to the centerline of each corresponding hollow cavity 94, said partition walls 93 defining said horizontally positioned hollow cavities 94. Each hollow cavity 94 having centerline parallel to the planar base surface 98. The load carrying walls 93 are having inwardly formed surfaces, staring at the open ends within the recessed portions 92. The intersections of each two inwardly formed surfaces can be fillet so that smooth ejection cycle can be achieved. The depth of each hollow cavity can be terminated anywhere from about 0.05 to 0.50 inch from the mid point of said marker base depth. The reflective faces 91 each can have one row or two rows of hollow cavities. The discontinuous grooves within the planar base surface 98 can have various sizes, shapes and depths, said depth can be of about 0.03 to 0.50 inch.

The present invention includes within its scope a method for making the monolithically formed reflective pavement marker or delineator, comprising the steps:

selecting the pavement marker shape, polymers to be used, types of cube corner reflective elements to be used, body shape, shape of reflective cells used and the injection molding method to be utilized for said method of making,

providing a tooling means which allow the injection molding of said reflective pavement marker body, integrally including the hollow cavities and the sealed planar base surface in one step, said tooling can be made to mold said marker having one color or two colors, and the tooling means for molding of the reflective plates integrally with cube comer reflective elements.

coating the reflective plates for abrasion resistance, either with diamond like film or silicon dioxide film utilizing plasma enhanced chemical vapor deposition techniques

providing hollow cavity means with rounded wedge shaped top surfaces which allow the cube corner reflective elements to be freely within air gaps inside of said hollow cavities,

providing the angular position of said hollow cavity means with respect to the inclined reflective face of said pavement marker body to allow uninterrupted ejection cycle during said injection molding of said reflective pavement marker body.

It is understood that various changes or modifications can be made within the scope of the appended claims to the above-preferred method of forming one-piece reflective marker without departing from the scope and the spirit of the invention. The principle processes of this invention are not limited to the particular embodiments described herein. Various embodiments can employ the processes of this invention. This invention is not limited to the exact method illustrated and described; alternative methods can be used to form the intended monolithically formed reflective pavement marker body as well as the reflective plates of this invention.

Therefore, the invention can be practiced otherwise than as specifically described herein.

What is claimed is:

1. A reflective roadway marker having a monolithically formed one piece hollowed body, said one piece body comprises: two arcuate sides, a top portion, a sealed planar base surface with textured discontinuous grooves and two inclined planar faces, each of said planar faces having a planar recessed portion;
means for integrally forming multiple of hollow cavities within said one piece body, said hollow cavity means having open ends at the planar recessed portion of said inclined planar faces, said hollow cavity means being formed either within one row or two rows, said hollow cavity means separated from each other by partition and load carrying walls, said hollow cavity means each having a centerline parallel to said planar base surface;
means for integrally forming plurality of wedge shaped top surfaces at the end of said load carrying partition walls within said planar recessed portions of said inclined planar faces, said wedge means being adopted to maximize the air gap areas at the open ends of said hollow cavity means; and
reflective plate means for attachment to said wedge means and the periphery of said planar recessed portions of said inclined planar faces, said plate means having inside surface with multiple of cube-corner reflective elements and planar outside surface, said inside surface welded to said wedge means thereby fusing portion of the cube corner reflective elements to said wedge means, whereby defining cell like areas within said inside surface, each cell with multiple of the remaining cube corner reflective elements.

2. The roadway marker as defined in claim 1, wherein each inclined planar face integrally includes a recessed portion where a reflective plate means is attached, said recessed portion includes the wedge means of said load carrying partition walls, said load carrying walls each having inwardly inclined surface defining said hollow cavity means, said inclined surfaces forming an angle of about 2 to 5 degrees with respect to the centerline of each corresponding hollow cavity means, said hollow cavity means having smooth round corners between each two of said inclined surfaces.

3. The roadway marker as defined in claim 1, where said hollow cavity means integrally being formed having centerlines parallel to said planar base surface, said hollow cavity means having depths that terminate about 0.05 to 0.50 inch from the center of said monolithically formed one piece body.

4. The roadway marker as defined in claim 1, wherein the planar base surface can have a width of about 4 to 5 inches and a depth of about 2.5 to 4 inches, said base surface having textured discontinuous grooves, said grooves having depth of about 0.03 to 0.50 inch.

5. The reflective roadway marker as defined in claim 1, wherein the one piece structural body can be made of various compatible polymeric materials, said material can be either a non reinforced thermoplastic polymer or fiber reinforced polymer with high impact resistance, said polymeric material can be filled with additive filler materials for strength or pigmentation.

6. The roadway marker as defined in claim 1, wherein the reflective plate means made of transparent polymeric material, said plate means having an inside surface with multiple of cube corner reflective elements, said inside surface welded to the wedge shaped top surfaces of said load carrying partition walls thereby forming reflective cell like surfaces retained within each hollow cavity means, each of said cell like surfaces with multiple of cube-corner reflective elements.

7. The reflective roadway marker as defined in claim 1, wherein the outside surfaces of the plate means can be coated with a single layer or multi layers of abrasion resistance diamond like carbon film or silicon dioxide film, utilizing plasma-enhanced chemical vapor deposition techniques or other evaporative coating materials or methods.

8. A retro reflective roadway marker comprising:
one piece hollowed structural body and at least one reflective plate attachment, said one piece body integrally formed comprising a sealed planar base surface with textured discontinuous grooves, two arcuate sides, two hump portions each having concave curve shaped reflective face, said reflective face having a planar recessed portion, said recessed portion includes wedge shaped top surfaces of load carrying partition walls defining multiple hollow cavities integrally within said one piece body, said hollow cavities having centerlines parallel to said planar base surface, said two hump portions connected by a scalloped recess portion.

9. The reflective roadway marker as defined in claim 8, wherein a reflective plate is welded to each recessed portion of the reflective faces, thereby fusing portion of the inside surface of said reflective plate with multiple cube corner reflective elements to the wedge shaped top surfaces of said load carrying partition walls.

10. The reflective roadway marker as defined in claim 8, wherein the reflective plate attachment is made of transparent polymeric material, said reflective plate having outside planar surface with multiple of reflective cells corresponding to the sizes and shapes of said open ends of hollow cavities within said reflective faces of said one piece body, said outside reflective cells being defined by slightly raised ridges.

11. The reflective roadway marker as defined in claim 8, wherein the one piece body can be made of recycled or virgin engineering plastic or any suitable structural polymeric material with high impact resistance, said polymeric material to be compatible for sonic welding to said reflective plate material.

12. A method for making the reflective pavement marker having a monolithically formed one-piece body, comprising the steps:
a) selecting the pavement marker shape, polymers to be used, types of cube corner reflective elements to be used, shape of reflective cells used and the injection molding method to be utilized for said method of making.
b) providing a tooling means which allow the injection molding of said reflective pavement marker body, integrally including the hollow cavities and the sealed planar base surface in one step, said tooling can be made to mold said marker body having one color or two colors, and the tooling means for molding of the reflective plates integrally with cube corner reflective elements.
c) coating the reflective plates for abrasion resistance, with either diamond like film or silicon dioxide film.
c) providing hollow cavity means with rounded wedge shaped top surfaces which allow the cube corner reflective elements to be freely within air gap spaces inside of said hollow cavities,
d) providing the angular position of said hollow cavity means to be parallel to the planar base surface, thereby allowing uninterrupted ejection cycle during said injection molding of said reflective pavement marker body.
e) Welding the reflective plates to the recessed portions of the inclined faces of said one piece pavement marker body, thereby having a reflective pavement marker.
